(19) United States
(12) Patent Application Publication
(10) Pub. No.: US 2011/0203479 A1
(43) Pub. Date: Aug. 25, 2011

(54) TRANSPORTATION SYSTEM THAT TRAVELS BY THE FORCE OF GRAVITY

(76) Inventor: Hak Kyu Jung, Seoul (KR)

(21) Appl. No.: 13/124,597

(22) PCT Filed: Oct. 12, 2009
(86) PCT No.: PCT/KR2009/005819

§ 371 Date: Apr. 15, 2011

(30) Foreign Application Priority Data
Oct. 15, 2008 (KR) 10-2008-0101053

(51) Int. Cl. B61C 7/00; B61H 11/00; H02K 7/18

(52) U.S. Cl. 104/287; 290/52

(57) ABSTRACT

The present invention relates to a transportation system wherein transportation means travel simply through the principle of a free fall by gravity, without using power, to carry or transport objects such as humans or freight. The transportation system of the present invention comprises a heavy object load station, a rail and transportation means. The heavy object load station is formed on undulating ground to easily utilize the force of gravity, and supplies heavy objects to provide the force for drawing the heavy objects in one direction in which gravity pulls. The rail supports vehicle wheels to reduce the running resistance of the vehicle wheels. The transportation means include vehicle wheels arranged in the lower portion thereof to travel along the rail, an operation compartment formed on the inside thereof, a heavy object compartment for loading the heavy object supplied from the heavy object load station, and a passenger compartment formed in rear of the heavy object compartment to carry passengers or freight. The transportation means travel over the undulating ground by gravity. [Keywords] gravity, sliding, transportation system.

### TECHNICAL FIELD

The present invention relates to a transportation system wherein transportation means travel simply through the principle of a free fall by gravity, without using power, to carry or transport objects such as humans or freight.

### BACKGROUND ART

Currently, most of transportation means use oil or electric energy as their main power source. Energy issues such as global exhaustion of petroleum resources face already grave situation, and development of alternative energy is an urgent issue.

To that end, it is clear that the solution to the energy exhaustion will also be required in the future, and a solution to the environmental contamination (due to CO₂ and greenhouse effect) should be found.

Accordingly, the purpose of the present invention is to provide a new transportation system which carries freight or passengers by gravy, unlimited clean energy, without using oil or electricity to thereby contribute to the resolution of energy and environmental issues.

### DISCLOSURE

As shown in FIGS. 1 to 13, a transportation system 100 which travels by the force of gravity includes an undulating ground 110, a rail 120 and transportation means 130.

The undulating ground 110 has one side which is higher, and the other side which is lower to provide the force of gravity more efficiently.

The undulating ground 110 includes the surface of land, but not limited thereto. Alternatively, the undulating ground 110 may be formed by installing a support on the ground or underground to form a particular height.

Accordingly, the undulating ground 110 may be formed on the surface of land or the ground in a desired shape or may include an undulating ground that is formed naturally.

On the undulating ground 110, a heavy object load station 140 is formed to supply a heavy object to thereby provide the force for drawing the heavy object in one direction in which gravity pulls.

The heavy object load station 140 may be installed on the highest location of the undulating ground 110, i.e., on one side of high ground or formed plurally in various locations of the undulating ground 110.

The heavy object load station 140 supplies the heavy object to a heavy object compartment 132 which is formed in the transportation means 130. The heavy object may include, e.g., standardized metal, stone, earth or other types of solid heavy objects, or water or liquid type heavy objects.

In the heavy object load station 140, a water tank 141 which includes a pipe 141a and an opening/closing valve 141b is formed to supply water to a fluid storage compartment 132b formed in the heavy object compartment 132 of the transportation means 130 to thereby supply heavy objects such as water or fluid.

The rail 120 is formed on the undulating ground 110 to support vehicle wheels 134 of the transportation means 130 and reduce the running resistance of the vehicle wheels 134. A guide unit 11 which includes a guiding groove 121a is formed in opposite upper sides of the rail 120.

A lubricant such as oil may be applied to the rail 120 to reduce the running resistance from the friction force with the vehicle wheels 134 of the transportation means 130 and enable an easier running.

The vehicle wheels 134 are formed in the lower portion of the transportation means 130 to run on the rail 120, an operation compartment 131 which includes various switches is formed inside of the transportation means 130 for a safe running, and the heavy object compartment 132 is formed in the operation compartment 131 to load a heavy object supplied through the heavy object load station 140 to travel by gravity.

The transportation means 130 travel over the undulating ground 110 by a free fall, or move by its own power or may be pulled and moved by another transportation means to move to the highest ground of the undulating ground 110. For the movement to the high ground as above, the configuration of the transportation means 130 may vary, and the detailed description will be omitted.

A body of the transportation means 130 is shaped like a body of an airplane or train, and the front and back of the transportation means 130 have the symmetrical structure, and the transportation means 130 include a light material, for example, FRP or aluminum material.

The heavy object compartment 132 includes a loading compartment 132a to load solid heavy objects, and a fluid storage compartment 132b to store therein fluid heavy objects such as water.

In rear of the heavy object compartment 132, a passenger compartment 133 which has a seat 138 installed therein is formed to carry and transport both passengers and freight.

The heavy object compartment 132 is located in rear of the operation compartment 132, but not limited thereto. Alternatively, the heavy object compartment 132 may be located in the middle or in rear of the transportation means 130 or other plural locations wherever necessary.

A winch 135 is formed in one side of the transportation means 130 to accommodate and support a cable 135c. The cable 135c is formed in the winch 135 to safely support the travel of the transportation means 130.

The cable 135c is wound to the winch 135 and is guided and unwound or wound by a cable holder 137 when the transportation means 130 travel.

The winch 135 may wind or unwind the cable 135c by itself and may be separated. Thus, the winch 135 may be separated from the cable 135c and mounted in the front and back of the transportation means 130 for a convenient operation.

If the winch 135 is connected to the transportation means 130, a connector 135a is formed to be fixed by a shaft 135b and moves to the left and right centering on the shaft 135b.

The foregoing configuration allows the transportation means 130 to move to the left and right to some extent even during a linear travel so that the transportation means 130 do not receive excessive force or shock.

Also, with the foregoing configuration, the rail 120 may move downward at certain angles.

When traveling by a free fall by gravity on the undulating ground 110 on which the rail 120 is installed, the transportation means 130 may travel by a free fall with the support of the cable 135c formed in the winch 135, or may travel by a free fall without the cable 135c.

The transportation means 130 should move to the high ground of the undulating ground 110 to travel by a free fall by gravity. In such a case, two transportation means are connected to each other by the winch 135 including the cable 135c, and then one transportation means pulls the other one to the high ground of the undulating ground 110.

The transportation means 130 may suspend its travel or may be fixed on the undulating ground 110 or other areas by a brake system or by a fixture B such as a support.

The fixture B may move to the left and right and may be located in the front of each of the vehicle wheels 134 to prevent the vehicle wheels 134 from moving downwards.

Further, a projection may be installed on the ground on which the vehicle wheels 134 are located not to move the vehicle wheels 134 downwards to thereby stop the transportation means 130.

Alternatively, the transportation means 130 may include various types of brake systems to stop as long as such brake systems are safe and strong.

The transportation means 130 includes various brake safety devices which will be described later.

As shown in FIG. 3, the seat 138 has a connection arm 138b formed in a fixing shaft 138a to move freely, and a bent plate 138c is connected to an upper side of the connection arm 138b.

A cushion mat 138d, a water sheet 138e and a bent object seat 138f are installed on the bent plate 138c to make a comfortable seat.

That is, the part of the seat 138 is formed by the water sheet 138e and the buoyant force of water sets off the gravity so that passengers may enjoy a comfortable travel with a feeling similar to a weightless state.

Other members which are located between the bent plate 138c and the bent object sheet 138f may be bent at particular angles so that passengers may get on the transportation means 130 in the most comfortable state.

As shown in FIG. 4, the vehicle wheels 134 are formed in the lower portion of the body of the transportation means 130 to rotate and move along the rail 120, and a brake system (not shown) which is used for trains is provided in the vehicle wheels 134.

A shock absorber 134a is installed in a lower surface of the transportation means 130 to absorb shock, and a guide device or a side brake system 139 is further provided in a lateral side of the body of the transportation means 130 for safety of the brake system.

That is, the side brake system 139 includes a brake shaft 139a forming an elastic body 139b for absorbing shock from the lateral side of the body of the transportation means 130 and a roller 139c connected to an end part of the brake shaft 139a.

The vehicle wheels 134 of the transportation means 130 are installed on the upper surface of the rail 120 to roll and move. The roller 139c of the side brake system 139 is installed in the guide groove 121a of the guide unit 121 to support the lateral side of the vehicle wheels 134 by rolling to thereby prevent the derailing of the vehicle wheels 134 and partial wear of the vehicle wheels 134 and enable an easier and safer travel.

The side brake system 139 guides the travel of the transportation means 130 traveling on the rail 120 to prevent the derailing of the vehicle wheels 134 and partial wear of the rail 120 and the vehicle wheels 134 and assist a safe travel.

If there is an error or malfunction in a main brake system of the transportation means 130, the side brake system 139 may operate to secure a safe travel.

The transportation means 130 include a resistance object 136 which is shaped like an airplane wing, moves by itself, and moves vertically and operates a brake by air resistance to reduce the travel speed or suspend the travel.

The resistance object 136 is shaped like an airplane wing, and plurally formed in the left and right side of the body of the transportation means 130, and may roll, pitch and yaw centering on the shaft 136a.

As shown in FIGS. 5 and 6, the resistance object 136 may stand or maintain a horizontal state centering on a resistance object shaft 136a.

Thus, the resistance object 136 is located horizontally as in FIG. 5 not to receive resistance when the transportation means 130 travel. When the transportation means 130 are to be stopped, the resistance object 136 moves and is located vertically to have the maximum resistance as in FIG. 6.

More specifically, as shown in FIG. 7, a plurality of sliding panels 136b is installed in one side of the resistance object 136, a surface directly facing wind when the resistance object 136 stands, i.e., in the state before being located vertically to have the maximum resistance.

When the resistance object 136 stands vertically, the sliding panels 136b are inserted into the body of the resistance object 136 and form a space 136c therein to receive the maximum air resistance. This is most advantageous for the operation of the brake by the air resistance.

FIG. 8 illustrates a resistance object according to another exemplar embodiment of the present invention. As shown therein, in a lateral side of the resistance object 150, an elastic wing 151 which includes a strong and elastic material is formed to generate a resistance force by being swollen like a balloon by pressure when contacting air.

A blind 151a which is open and closed is formed in a lateral side of the resistance object 150. For example, several blinds 151a may be provided at a predetermined interval, and may be controlled independently.

Then, when the resistance object 150 moves and stands vertically, the blinds 151a are controlled to be open and closed in the desired number so as to adjust the degree of air resistance, i.e., operation of the brake.

When the transportation means 130 travel, the resistance object 150 is located horizontally like an airplane wing. To operate the brake by air resistance, the resistance object 150 stands vertically and controls the blinds 151a. Then, the elastic wing 151 is swollen and operates the brake as shown in FIG. 8.

The resistance object 150 may vary other than the foregoing configuration.

FIG. 9 illustrates a resistance object according to another exemplary embodiment of the present invention. As shown therein, a plurality of partition walls 161 is formed in a power resistance object 160, and a fan is formed in each of the partition walls 161. An opening and closing panel 163 is formed in front of the fan 162.

Then, the power resistance object 160 may receive or block air by opening or closing the opening and closing panel 163.

An additional power resistance object (not shown) may be formed on top of the transportation means 130.

FIG. 10 is a lateral view of the resistance object in FIG. 9. As shown therein, in addition to the opening and closing panel 163 formed in the power resistance object 160, a front opening and closing panel 164 may be formed in the front to slide.

Only the front opening and closing panel 164 may be installed and the opening and closing panel 163 may be omitted as necessary.

The power resistance object 160 may be provided in various shapes to expose the fan 162.

With the foregoing configuration, the power resistance object 160 stands and receives the maximum air resistance when the transportation means 130 reduce speed. If the front opening and closing panel 164 and/or the opening and closing panel 163 is open and receives air resistance with the fan 162 exposed to the outside, the fan 162 rotates by the air resistance to thereby rotate a power generating shaft 162a and electricity may be stored in an electric condenser 166 through a power generator 165.

The electricity stored in the electric condenser 166 may be used as energy for the transportation means 130.

FIG. 11 illustrates the resistance object 136 or the resistance object 150 and the power resistance object 160 installed in the transportation means 130 according to the present invention. The resistance object 136 or the resistance object 150 and the power resistance object 160 enable a more efficient operation of the brake and generate power by rotating the fan 162 of the power resistance object 160 by air resistance. The generated electricity is stored in the electric condenser.

### BRIEF DESCRIPTION OF DRAWINGS

FIG. 1 illustrates a preferable exemplary embodiment of the present invention.

FIG. 2 illustrates a lateral internal structure of transportation means according to the preferable exemplary embodiment of the present invention.

FIG. 3 illustrates a seat formed within the transportation means according to the present invention.

FIG. 4 is a front view of the transportation means according to the present invention.

FIG. 5 is a plan view of a resistance object formed in the transportation means according to the present invention.

FIG. 6 is a lateral view of an operation state in FIG. 5.

FIG. 7 illustrates a resistance object according to a preferable exemplary embodiment of the present invention.

FIG. 8 illustrates a resistance object according to another preferable exemplary embodiment of the present invention.

FIG. 9 illustrates a resistance object according to another preferable exemplary embodiment of the present invention.

FIG. 10 is a sectional view to describe an operation state of the resistance object in FIG. 9.

FIG. 11 illustrates the resistance object in FIG. 7 or 8 and 9 when installed in the transportation means.

FIGS. 12 and 13 illustrate usage of the transportation means according to the present invention.

FIG. 14 illustrates another exemplary embodiment of the present invention.

FIG. 15 illustrates another exemplary embodiment of the present invention.

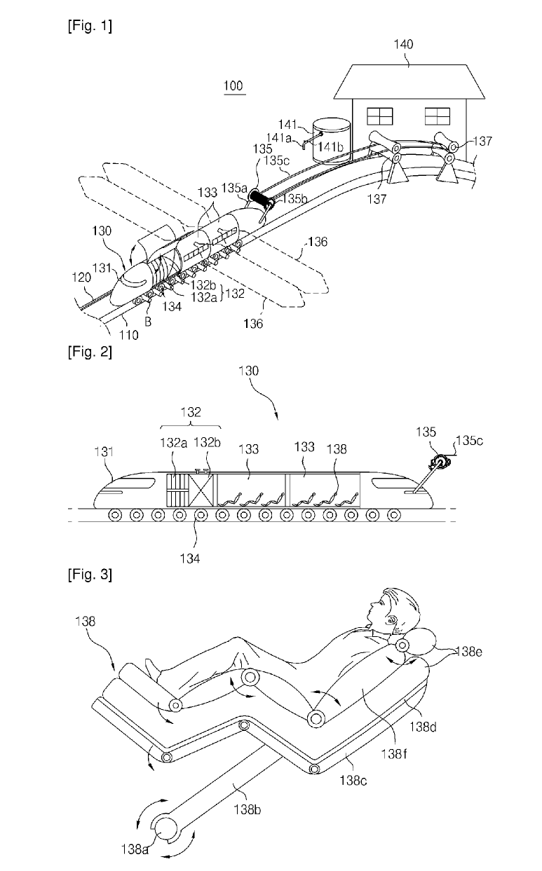

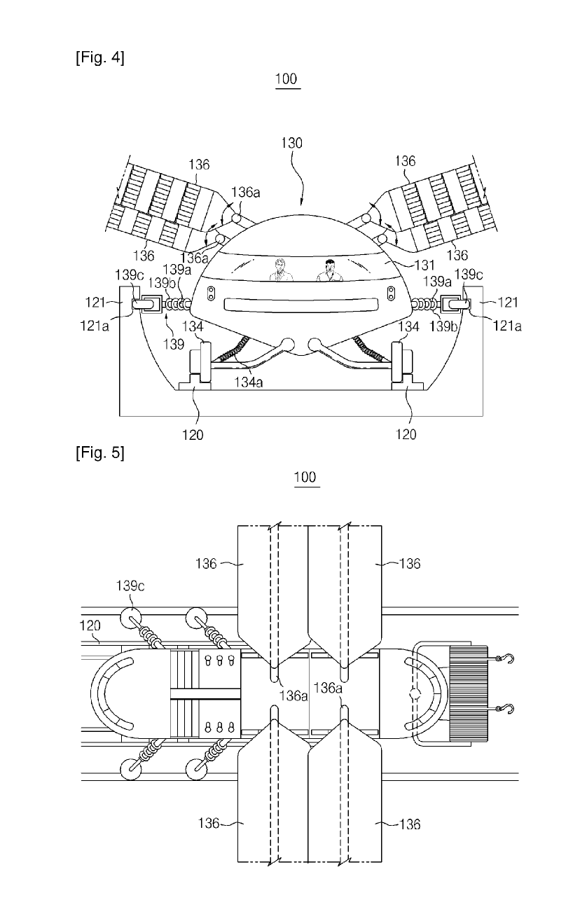

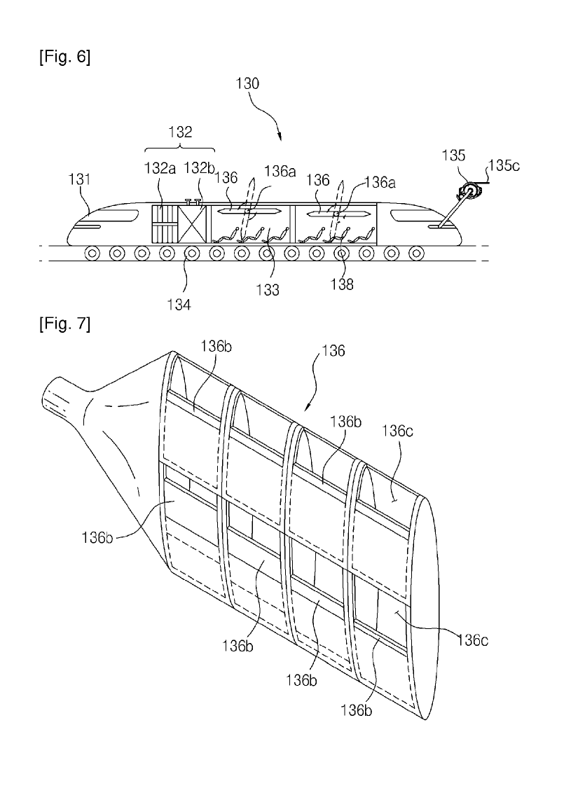

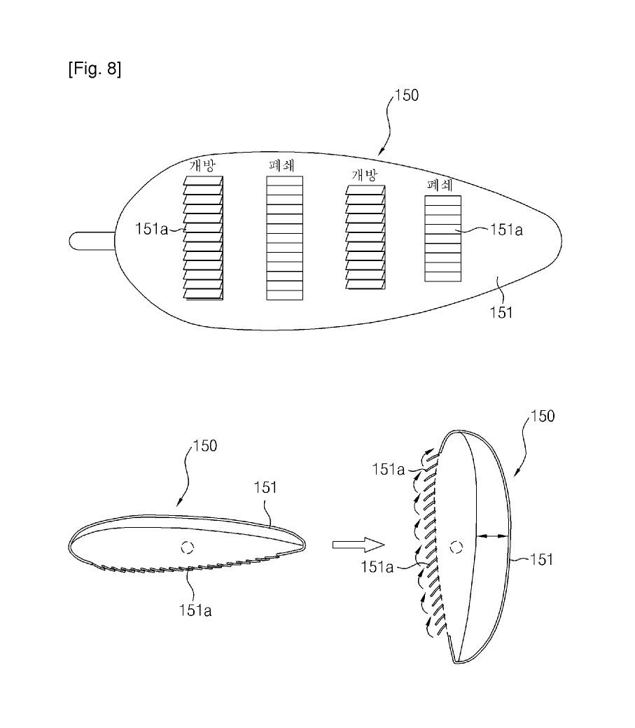

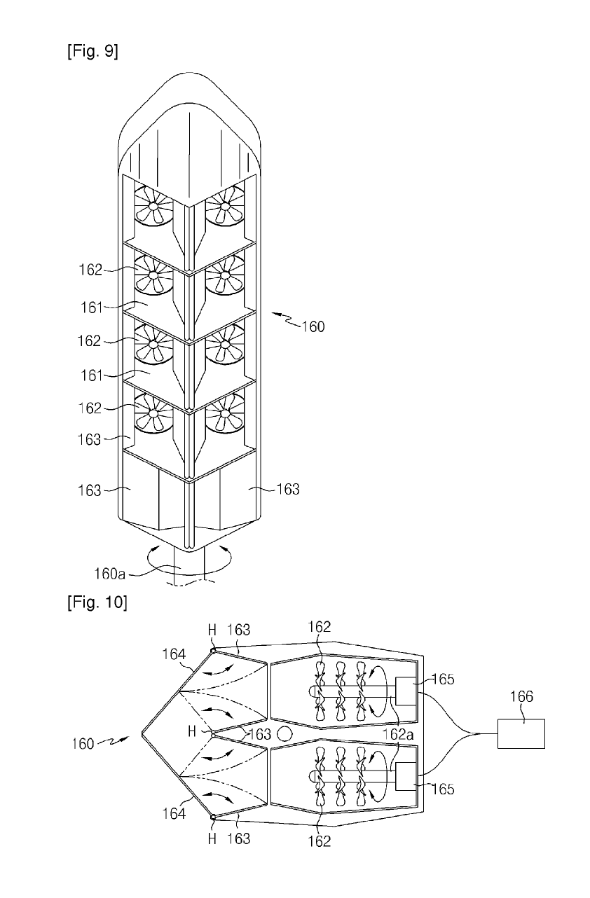

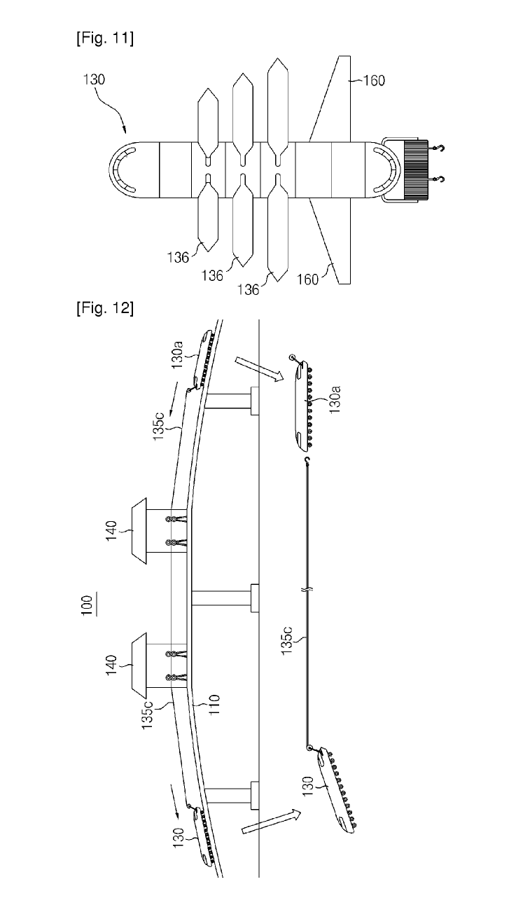

### DESCRIPTION OF NUMERALS OF MAJOR PARTS OF DRAWINGS

100: transportation system 110: undulating ground
120: rail 121: guide
121a: groove 130: transportation means
131: operation compartment 132: heavy object compartment
132a: loading compartment 132b: fluid storage compartment
133: passenger compartment 134: vehicle wheels
135: winch 135a: connector
135b: shaft 135c: cable
136,150: resistance object 136a: resistance object shaft
136b: sliding panel 136c: space
140: heavy object load station 141: water tank
141a: pipe 141b: opening and closing valve
151: elastic wing 151a: blind
160: power resistance object 161: partition walls
162: fan 163: opening and closing panel
164: front opening and closing panel 165: power generator
166: electric condenser B: fixture
H: hinge S: support shaft

### BEST MODE

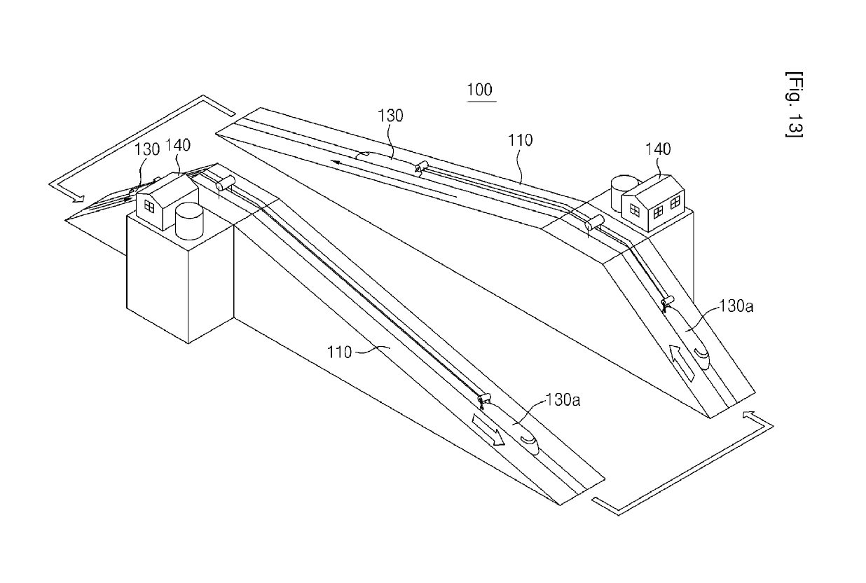

FIGS. 12 and 13 illustrate usage of transportation means according to the present invention. As shown therein, transportation means 130 and second transportation means 130a which are the same as the transportation means 130 are installed in the undulating ground 110. A heavy object load station 140 is formed on the highest ground of the undulating ground 110.

Solid heavy objects or fluid heavy objects are loaded onto the heavy object compartment 132 of the transportation means 130 at the heavy object load station 140, together with passengers or freight or both passengers and freight, and then the transportation means 130 move by a free fall.

Then, the transportation means 130 slide and move along the undulating ground 110 by its weight.

Then, the second transportation means 130a from the opposite undulating ground 110 are pulled by the difference of weight.

The second transportation means 130a are also loaded with heavy objects, freight or passengers to carry or transport them.

Since the second transportation means 130a should be as light as possible, sold heavy objects or fluid heavy objects loaded onto or supplied to a loading compartment 132a and a fluid storage compartment 132b formed therein should be removed therefrom in advance.

Otherwise, the second transportation means 130a may unload passengers or freight, and load only heavy objects to be pulled upward.

Solid heavy objects or fluid heavy objects are loaded onto the heavy object compartment of the second transportation means 130a at the heavy object load station 140 to make the second transportation means 130a weigh sufficiently. Then, the second transportation means 130a are loaded with passengers or freight like the transportation means 130a to move downward. Then, the transportation means 130, which moved downward already, move upwards after the loaded heavy objects are removed therefrom.

In this case, humans or heavy objects or freight may be carried by the transportation means 130 as necessary. This is possible since the second transportation means 130a in the opposite side have a weight to pull the weight of the transportation means 130 (generation of the transportation force by the difference of the relative weight).

The freight or passengers which are moved upward by the second transportation means 130a may be transferred to the transportation means 130 moving upward by the left and right/upward and downward movement to move to the opposite side.

As indicated by the arrow in FIG. 12, a hook may be formed in an end part of the cable 135c of the transportation means 130 to be connected to the front of the second transportation means 130a.

The transportation means 130 which are moved to the high ground as above move downwards again. Such configuration is applicable to the second transportation means 130a to move the transportation means up and down very conveniently (forming a closed loop).

In this case, the heavy objects may be removed to reduce the weight when the transportation means 130 are located in a low ground, or the transportation means 130 may be pulled to the heavy object load station 140 for unlimited usage.

The fluid heavy object which is loaded onto the transportation means 130 and the second transportation means 130a may be removed at a low ground. However, the unloaded solid heavy objects should be moved to the heavy object load station 140 for reuse. With the configuration as in FIGS. 12 and 13, the solid heavy objects may be easily moved to the heavy object load station 140.

That is, any object may be loaded onto the transportation means as long as the another transportation means weigh enough to pull the foregoing transportation means.

The transportation means 130 and 130a may be pulled and moved by the winch 135 including the cable 135c when the transportation means 130 and 130a are moved to the high ground of the undulating ground 110 on which the rail 120 is installed. Otherwise, the transportation means 130 and 130a may travel upward by using the power generated from the power resistance object 160.

Accordingly, the transportation means 130 and 130a may travel by a free fall or move upwards on the undulating ground 110 without the cable 135c.

The configuration of the transportation means 130 and 130a which move by a free fall or move upwards may vary within the scope of the technical spirit of the present invention as necessary.

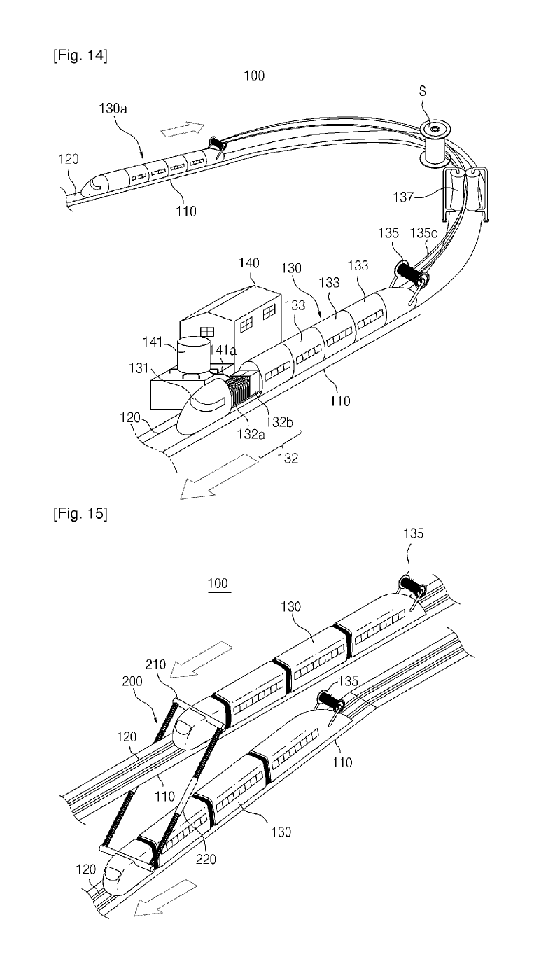

FIG. 14 illustrates another exemplary embodiment of the present invention. The undulating ground 110 is formed in opposite sides, and the rail 120 is installed on the undulating ground 110. A support shaft S which rotates by changing a movement direction freely is formed in the middle of the undulating ground 110. Then, the transportation means 130 and 130a are supported by the cable 135c wound to the winch 135 and the support shaft S and fall by gravity to travel.

The transportation means 130 and 130a travel by gravity in mines and other various industrial sites and transport objects such as humans and freight without additional energy such as electricity, oil or coal.

FIG. 15 illustrates another exemplary embodiment of the present invention. The undulating ground 110 is formed in a two-step structure. The rail 120 is installed on the two-step undulating ground 110. Then, a pulling bar 200 which includes a horizontal bar 210 and a vertical bar 220 is formed in one side of the upper transportation means 130 and the lower transportation means 130. Then, utilization of space increases further and transportation capability of the transportation means 130 and 130a increases when falling free.

The vertical bar 220 is elastic so that the transportation means 130 may travel safely and efficiently even in the case of an occurrence of a movement.

Although the present invention has been described with reference to the embodiment described above, it is not limited to the embodiment, and the present invention may be modified in various ways without deviating from the scope of the present invention.

### INDUSTRIAL APPLICABILITY

A transportation system according to the present invention travels by gravity and is applicable to various transportation and transportation technical areas.

For example, the transportation system may be downsized and used in factories when freight is transported from one location to another location. In this case, a ground structure is made to install a rail thereon. The ground structure should be inclined in a desired shape to thereby transport humans or freight.

Otherwise, the transportation system may transport humans or freight from one location to another location by using an undulating ground that is formed naturally.

In particular, in mountainous areas, the transportation system may easily transport freight or humans at a lower expense and utilizes the natural geographical features without cutting or damaging the land.

Also, the transportation system according to the present invention does not use energy such as oil or electricity to carry or transport freight or humans, and saves energy and is eco-friendly.

1. (canceled)

2. (canceled)

3. (canceled)

4. A transportation system which comprises a rail that is formed on an undulating ground and supports a heavy object load station supplying a heavy object for providing the force drawing the heavy object in one direction in which the gravity pulls and vehicle wheels to easily utilize the gravity and reduce a running resistance of the vehicle wheels, and transportation means comprising vehicle wheels arranged in the lower portion thereof to travel along the rail, an operation compartment formed on the inside thereof, a heavy object compartment for loading the heavy object supplied from the heavy object load station, and a passenger compartment formed in rear of the heavy object compartment to carry passengers or freight, and travels over the undulating ground by the gravity, the transportation system comprising:
a body of the transportation means being shaped like an airplane wing and comprising a resistance object which stands vertically to operate a brake by air resistance to thereby reduce the speed of the transportation means or to stop the transportation means.

5. The transportation system according to claim 4, wherein a power resistance object which comprises a fan is installed in the body of the transportation means and generates power by a rotation of the fan and stores such power in an electric condenser.

6. The transportation system according to claim 4, wherein a side brake which comprises a brake shaft forming an elastic object to absorb shock and a roller connected to an end part of the brake shaft is formed in a lateral part of the body of the transportation means.

7. The transportation system according to claim 4, wherein a guide unit which comprises a guide groove is formed in opposite sides of the rail.

8. The transportation system according to claim 4, wherein an upper surface of the resistance object comprises an elastic wing and a lower surface thereof comprises a blind that is open and closed and the elastic wing is swollen by air introduced to the inside of the resistance object by opening the blind and operates the air brake.
